(19) United States
(12) Patent Application Publication
(10) Pub. No.: US 2010/0174642 A1
(43) Pub. Date: Jul. 8, 2010

(54) SOLAR POWERED UTILITY

(75) Inventor: Christopher Hornor, Berkeley, CA (US)

Correspondence Address: FOLEY & LARDNER LLP, P.O. BOX 80278, SAN DIEGO, CA, 92138-0278, US

(73) Assignee: Better Energy Systems Ltd.

(21) Appl. No.: 12/683,391

(22) Filed: Jan. 6, 2010

Related U.S. Application Data
(60) Provisional application No. 61/143,124, filed on Jan. 7, 2009.

(51) Int. Cl. G06Q 30/00; H01M 10/46; H04W 4/00

(52) U.S. Cl. 705/39; 320/101; 705/1.1; 455/414.1

(57) ABSTRACT

Systems and methods for providing renewable energy to rural communities employ a solar powered charger and a key configured to activate the solar powered charger, where the solar powered charger is enabled for one or more charge and discharge cycles to provide electrical energy to a device configured to be operated or charged by the solar powered charger.

This application claims the benefit of U.S. Provisional Application No. 61/143,124, filed on Jan. 7, 2009, which is incorporated herein by reference in its entirety.

### TECHNICAL FIELD

Embodiments of the present invention are directed to systems and methods for facilitating the provision of electrical energy to rural economies and, in particular, for the micro-financing of electrical energy delivery based on solar technology.

### BACKGROUND

It is estimated that over the next few years, one billion rural villagers in third world and emerging economies will own their first mobile phone as cellular infrastructure reaches further and further from dense population centers. Today, these potential subscribers have limited incomes (e.g., $1 to $4 per day) and limited access to electricity, lighting and potable water. With such limited incomes, villagers do not have the means to purchase wind, solar or other energy solutions outright, and energy vendors have not found a way to ensure collection from payment plans or to provide cost effective service to the rural areas. Because there is no ready supply of electricity, villagers must rely on someone with a generator and a car battery, for example, to charge their phones for a fee. Additionally, lighting is often provided by lamps fueled with kerosene, which is expensive, dangerous and harmful to the environment. In many regions, potable water can only be had by walking great distances to a centralized well or a supply of stored water.

### SUMMARY

In one embodiment of the present invention, a system includes a solar powered charger and a key configured to activate the solar powered charger, wherein the solar powered charger is enabled for one or more charge and discharge cycles to provide electrical energy to a device configured to be operated or charged by the solar powered charger.

In one embodiment, the key is controlled by an agent and provided in exchange for a monetary payment from a user of the solar powered charger to enable the one or more charge and discharge cycles of the solar powered charger.

In another embodiment, the key is controlled by a user of the solar powered charger and is configured to be programmed with credits for the one or more and discharge cycles in exchange for a monetary payment.

In another embodiment, the solar powered charger is configured to identify the device when the solar powered charger is coupled to the device, to record times of connection to the device and the electrical energy transferred to the device.

In another embodiment, the key is further configured to read and store usage information from the solar powered charger including an identifier of the device, the times of connection to the device, the electrical energy transferred to the device and an identifier of the solar powered charger. In another embodiment, the key is further configured to communicate with a server via a connection through a cellular telephone network, wherein the usage information is transferred to the server. In another embodiment, the usage information transferred to the server is converted to a carbon credit.

In another embodiment, the connection to the cellular telephone network comprises a connection to a cellular telephone via one of an electro-mechanical connection, an electromagnetic connection and an audio connection.

In another embodiment, the key is configured to receive an activation code from the server, wherein a plurality of valid activation codes are stored in the solar powered charger and wherein activation of the solar powered charger comprises matching the activation code to one of the plurality of valid activation codes.

In another embodiment, to detect the device the solar powered charger is configured to read a characteristic value of a resistor in a connection path between the device and the solar powered charger.

In one embodiment, a system includes a solar powered charger and a cellular telephone configured to communicate with the solar powered charger, wherein the solar powered charger is configured to receive an activation code from a server via the cellular telephone and wherein the solar powered charger is enabled for one or more charge and discharge cycles to provide electrical energy to a device configured to be operated or charged by the solar powered charger.

In another embodiment, the activation code is provided by a service provider in exchange for a monetary payment from a user of the solar powered charger, where the monetary payment comprises an online transaction via the cellular telephone with one of the service provider and a third-party facilitator.

In another embodiment, the solar powered charger is configured to identify the device when the solar powered charger is coupled to the device, to record times of connection to the device and electrical energy transferred to the device. In another embodiment, the solar powered charger is further configured to transmit usage information from the solar powered charger to a server via a connection through a cellular telephone network, the usage information including an identifier of the device, the times of connection to the device, the electrical energy transferred to the device and an identifier of the solar powered charger.

In one embodiment, the solar powered charger is coupled to the cellular telephone network via the cellular telephone, where the connection to the cellular telephone comprises one of an electro-mechanical connection, an electromagnetic connection and an audio connection.

In another embodiment, the activation code is compared to a plurality of valid activation codes stored in the solar powered charger and the solar powered charger is activated if the activation code matches one of the plurality of valid activation codes.

In another embodiment of the present invention, a method includes: enabling a solar powered charger for one or more charge/discharge cycles in exchange for a monetary payment; connecting the solar powered charger to a device configured to be charged or operated by the solar powered charger; recording usage data in the solar powered charger; and uploading the usage data to a server. In one embodiment, the method further includes re-enabling the solar powered charger for another one or more charge/discharge cycles in exchange for another monetary payment.

In one embodiment, enabling the solar powered charger comprises receiving an activation code from the server and matching the activation code to a plurality of valid activation codes stored in the solar powered charger. In one embodiment, the activation code is transmitted from the server through a cellular telephone network to a cellular telephone configured to provide the activation code to the solar powered charger. In one embodiment, the cellular telephone is configured to interface with an activation key wherein the activation key is configured to interface with the solar powered charger, and the method further includes transferring the activation code from the cellular telephone to the activation key and transferring the activation code from the activation key to the solar powered charger. In one embodiment, the activation key is controlled by an agent and the agent receives the monetary payment.

In one embodiment, the method further includes providing the solar powered charger to a user under a lease-purchase plan, where the monetary payment is an electronic payment facilitated by a third-party provider over the cellular telephone network.

In one embodiment, the method further includes converting the usage data to a carbon credit and selling the carbon credit.

### BRIEF DESCRIPTION OF THE DRAWINGS

Embodiments of the present invention are illustrated by way of example, and not by limitation, in the figures of the accompanying drawings in which:

FIG. 1 illustrates a system according to one embodiment of the invention;

FIG. 2 illustrates a system according to another embodiment of the invention; and

FIG. 3 is a flowchart illustrating a method according to one embodiment of the invention.

### DETAILED DESCRIPTION

In the following description, numerous specific details are set forth, such as examples of specific commands, steps, named components and subsystems, connections, data structures, etc., in order to provide a thorough understanding of embodiments of the present invention. It will be apparent, however, to one skilled in the art that embodiments of the present invention may be practiced without these specific details. In other instances, well-known components or methods have not been described in detail but in a block diagram form in order to avoid unnecessarily obscuring the present invention. Thus, the specific details set forth are merely exemplary. The specific details may be varied from and still be contemplated to be within the spirit and scope of the present invention.

Systems and methods according to embodiments of the present invention make use of a solar powered battery/charger (“solar powered charger”) such as various models of the Solio™ solar powered charger manufactured by Better Energy Systems, Inc., of Berkeley Calif., for example. However, embodiments of the invention are not so limited. Solar powered chargers in accordance with the present invention may have, in addition to solar cells and rechargeable batteries, an architecture of a computer system including a processor, data and control buses, volatile and non-volatile memory, physical and user interfaces, and stored, executable software.

In one embodiment, a solar powered charger may be bundled with a cell phone and sold or leased to a subscriber (“user”) at a discounted price subsidized, for example, by a local cellular carrier or the manufacturer of the solar powered charger. The solar powered charger may be provided with one or more interface cables to provide a connection between the solar powered charger and one or more cell phone models, including at least the subscriber's own cell phone. The solar powered charger may be configured with hardware and/or software access controls to limit and control charge and discharge cycles of the solar powered charger. In particular, the hardware and/or software access controls may be used to enable one or more charge/discharge cycles of the solar powered charger when an activation code is transmitted to the solar powered charger, where the activation code may be provided in exchange for a monetary payment from the user. The solar powered charger may also be configured to operate and/or charge one or more devices configured, in turn, to communicate with the solar powered charger and to be charged and or operated by the solar powered charger. Such devices, to be described in greater detail below, may include for example, LED light sources, water purifiers and other cell phones.

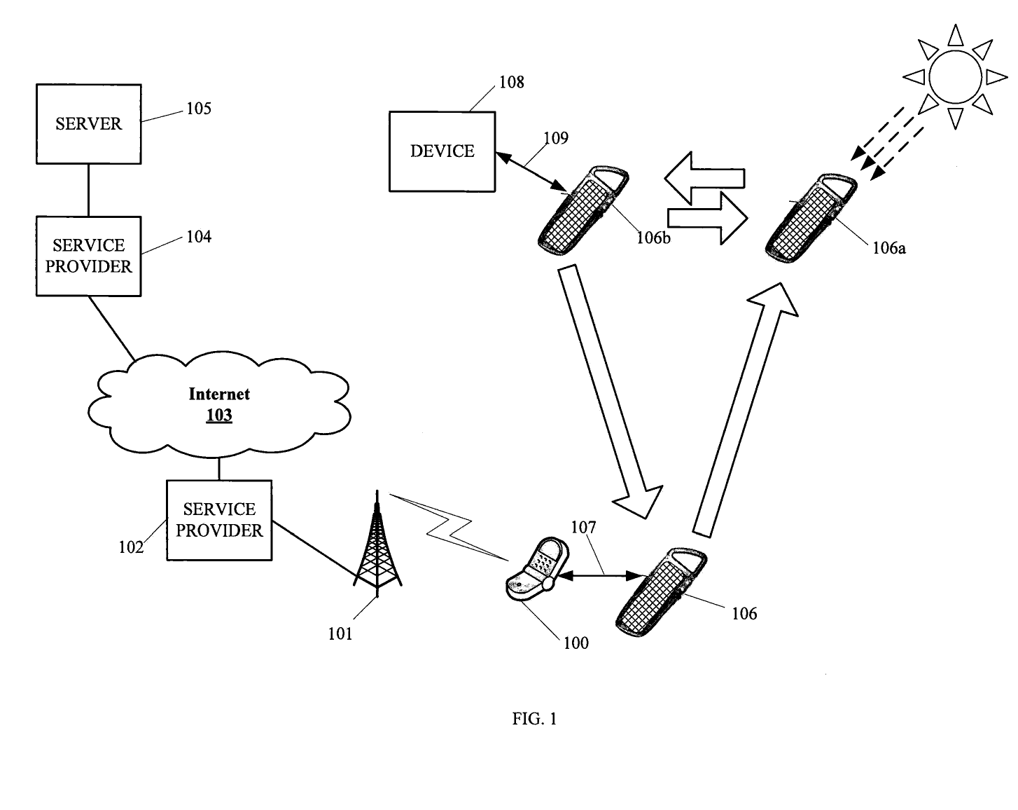

FIG. 1 illustrates a system according to one embodiment of the invention. In FIG. 1, a cell phone 100 is configured to communicate in a cellular system, represented symbolically by cell tower 101. A local service provider 102 provides access to the Internet 103, which in turn provides access to a remote service provided 104, and ultimately to a server 105. In one embodiment, the local service provider 102 may provide access to server 105 without a connection through the Internet (e.g., via a direct connection, LAN, WAN, intranet or extranet). A user of cell phone 100 may be provided with a telephone access number that provides access to server 105. Alternatively, the access number may be preprogrammed into the cell phone 100 by the cell phone provider or provided by an application resident in the cell phone. Once communication with the server 105 is established, The user may be prompted to connect solar powered charger 106 to the cell phone 100 via a connection 107. Connection 107 may be an electro-mechanical connection such as a cable, using an I²C protocol, for example. In other embodiments, connection 107 may be an electromagnetic connection such as a WiFi®, Bluetooth® or optical connection (e.g., IrDA), or an audio connection based on a set of audio command and control tones, which may be a proprietary or standardized (e.g., NSDT) tone set.

The solar powered charger 106 may have a unique identification number, such as a serial number, for example, that can be read by the cell phone 100 and transmitted to the server 105. The identification number may be associated with a user account maintained on the server 105. In other embodiments, the user account may be associated with the cell phone 100. The user account may include an account credit balance that the user can access to apply to cell phone usage and/or operation of the solar powered charger 106. The user may also be able to add to the credit balance by entering bank account, credit or debit card information. In rural environments, where users may not have access to bank, credit or debit accounts, the transaction may be facilitated by a third party, such as a retailer (e.g., a cell phone retailer) who can accept monetary payment from the user and credit the user's account on the server 105. Payments to the user account may be allocated among the manufacturer of the solar powered charger, the cellular service provider and any third party that may facilitate payment.

Solar powered charger 106 may have stored a plurality of valid activation codes, unique to the solar powered charger 106 and known to the server 105. In one embodiment, in exchange for a monetary payment in the form of an account debit, the server 105 may enable the solar powered charger 106 by transmitting one of the valid activation codes to the solar powered charger 106 through cell phone 100. The solar powered charger 106 may thereafter be enabled for one or more charge and discharge cycles as described in greater detail below. In one embodiment, the system may have a failsafe mode that operates in the event that cell phone 100 is discharged and unable to initiate a call to the server 105.

In failsafe mode, solar powered charger 106 may be configured to detect that the cell phone 100 is discharged and, if the solar powered charger 106 has a charged or partially charged battery, to provide a trickle charge to the cell phone 100 sufficient to support a call and a connection to the server 105. And, if the solar powered charger 106 does not have a charge, it may have a default mode that allows it to accept a solar charge sufficient to subsequently charge and operate the cell phone 100.

After the solar powered charger 106 has been enabled as described above, it becomes a chargeable solar powered charger 106a, as illustrated in FIG. 1, which may be charged up to the number of times authorized during the enablement operation. After full or partial charging, the solar powered charger becomes a charged solar powered 106b capable of charging and/or operating a device 108 configured to be charged and/or operated by solar powered charger 106b. Device 108 may be coupled to solar powered charger 106b by an electro-mechanical connection 109 such as a cable configured for transmission of electrical energy and data between the device 108 and the solar powered charger 106b. Device 108 may be, for example, a cell phone, a light source such as an LED light source, or a water purifier. Device 108 may be a device owned by the owner/user of the solar powered charger 106.

In one embodiment, device 108 may be in the possession of a third party who may pay the owner/user of solar powered charger 106b for charging services, so that the owner/user of the solar powered charger has a sustainable means for financing the ongoing enablement of the solar powered charger 106.

Device 108 and solar powered charger 106 may be configured to exchange data while they are coupled. In particular, data transmitted to the solar powered charger may include an identifier of the device 108 and the amount of electrical energy transferred to the device 108 from the solar powered charger 106. This data may be used later, as described in greater detail below, to generate carbon credits for the non-renewable resources, such as kerosene fueled lighting, that is replaced by the energy supplied by the solar powered charger 106.

After the charge in the solar powered charger 106 is depleted, the solar powered charger 106 may be recharged as illustrated in FIG. 1, and returned to service to charge and/or operate a device 108. This cycle may be repeated until the enabled number of charge cycles has been reached, in which case the solar powered charger 106 may be recoupled with the cell phone 100 to re-enable the solar powered charger 106 for additional charge and discharge cycles. When the solar powered charger 106 is recoupled to the cell phone 100, the data transmitted to the solar powered charger during its connection to device(s) 108 may be transmitted to server 105 where the renewable solar energy delivered to device 108 may be converted to an equivalent carbon credit. The carbon credit may then be monetized and sold to the benefit of the manufacturer of the solar powered charger 106, the service provider 102, and/or the user of the solar powered charger (or some combination thereof).

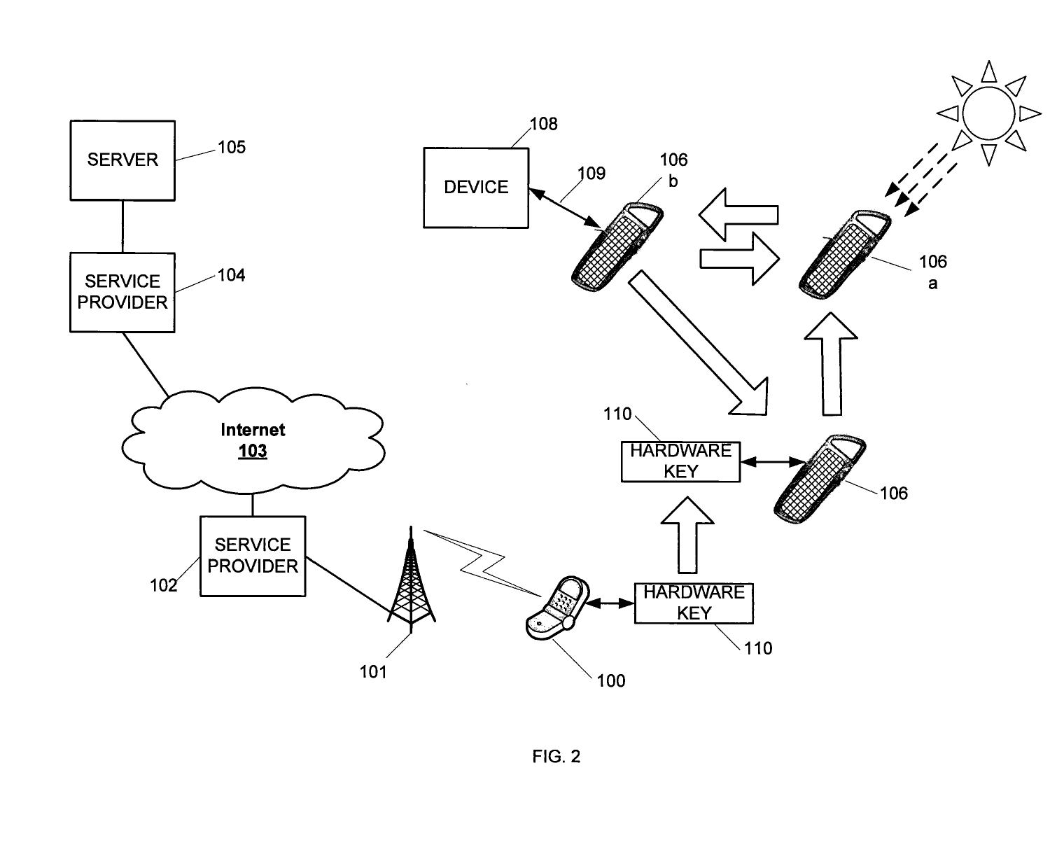

FIG. 2 illustrates a system according to another embodiment of the invention. In FIG. 2, cell phone 100, cellular system 101, local service provider 102, Internet 103, remote service provider 104 and server 105 operate as described above in reference to FIG. 1. The embodiment illustrated in FIG. 2 differs from FIG. 1 at least in the use of a hardware key 110 as an intermediary between cell phone 100 and solar powered charger 106, where the hardware key is used to receive activation codes from the server 105, to enable the solar powered charger for one or more charge and discharge cycles, and to transfer usage data from the solar powered charger to the server 105 as described in greater detail below.

In one embodiment, hardware key 110 may be in the possession and control of an agent who provides a service to the users of solar powered chargers in exchange for a monetary payment. In this embodiment, cell phone 100 may also be in the possession and control of the agent, such as a local cell phone and-or solar powered charger retailer. In other embodiments, the hardware key 110 and the cell phone 100 may be in the possession and control of the user of the solar powered charger. In the following description, the terms user and agent are used interchangeably.

Hardware key 110 may include hardware and software configured to store programs and data that enable the hardware key to receive activation codes from server 105 and transfer the activation codes to solar powered chargers to enable the solar powered chargers for charge and discharge cycles as described above.

When communication with the server 105 is established with the cell phone 100 as described above, the user may be prompted to connect the hardware key 110 to the cell phone 100 via a connection 107 as described above. The hardware key 110 may have stored data containing a unique identification number for the solar powered charger 106, based on a previous connection with solar powered charger 106, and associated with a user account maintained on the server 105 as described above. In exchange for a monetary payment in the form of a debit transaction, the server 105 may supply an activation code through the cell phone 100 to the hardware key 110, where the activation code one of a plurality of valid activation codes for the solar powered charger 106, known to the server 105 based on the account information.

The hardware key 110 may then be coupled to the solar powered charger 106 for activation of the solar powered charger 106, after which the solar powered charger is enabled for one or more charge and discharge cycles. As illustrated in FIG. 2, the now chargeable solar powered charger 106a may be charged by exposure to solar radiation.

After full or partial charging, the solar powered charger becomes a charged solar powered 106b capable of charging and/or operating a device 108 configured to be charged and/or operated by solar powered charger 106b. Device 108 may be coupled to solar powered charger 106b by an electro-mechanical connection 109 such as a cable configured for transmission of electrical energy and data between the device 108 and the solar powered charger 106b. Device 108 may be, for example, a cell phone, a light source such as an LED light source, or a water purifier. Device 108 may be a device owned by the owner/user of the solar powered charger 106.

In one embodiment, device 108 may be in the possession of a third party who may pay the owner/user of solar powered charger 106b for charging services, so that the owner/user of the solar powered charger has a sustainable means for financing the ongoing enablement of the solar powered charger 106.

Device 108 and solar powered charger 106 may be configured to exchange data while they are coupled. In particular, data transmitted to the solar powered charger may include an identifier of the device 108 and the amount of electrical energy transferred to the device 108 from the solar powered charger 106. This data may be used later, as described in greater detail below, to generate carbon credits for the non-renewable resources, such as kerosene fueled lighting, that is replaced by the energy supplied by the solar powered charger 106.

After the charge in the solar powered charger 106 is depleted, the solar powered charger 106 may be recharged as illustrated in FIG. 2, and returned to service to charge and/or operate a device 108. This cycle may be repeated until the enabled number of charge cycles has been reached. When the solar powered charger 106 is ultimately depleted (except for a failsafe mode that retains a residual charge or supports a limited solar recharge to support subsequent operations), it may be recoupled with the hardware key 110. When the solar powered charger 106 is recoupled to the hardware key 110, the usage data transmitted to the solar powered charger during its connection to device(s) 108 may be transferred to hardware key 110. The hardware key 110 may then be coupled to the server 105 via the cell phone 100 and where the usage data is transferred to the server and the renewable solar energy delivered to device(s) 108 may be converted to an equivalent carbon credit and monetized as described above. During the connection, or a subsequent connection, the hardware key may receive another activation code from the server in exchange for another monetary payment.

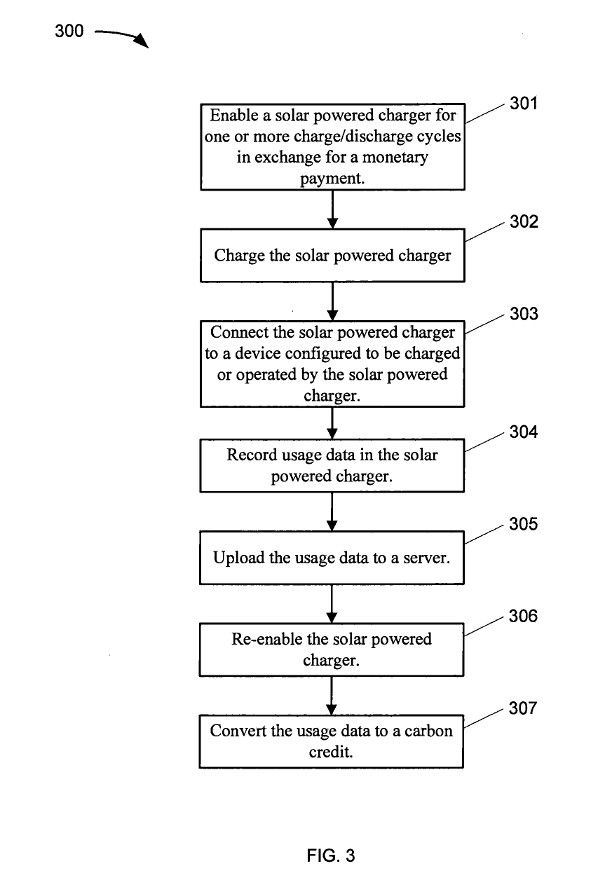

FIG. 3 is a flowchart illustrating a method 300 according to one embodiment of the present invention. In operation 301, a solar powered charger, such as solar powered charger 106, is enabled for one or more charge and discharge cycles in exchange for a monetary payment. In operation 302, the solar powered charger is charged by exposure to solar energy. In operation 303, the solar powered charger is connected to a device configured to be charged or operated by the solar powered charger. In operation 304, usage data is recorded in the solar powered charger. In operation 305, the usage data is uploaded to a server and the solar powered charger may be re-enabled. In operation 307, the usage data is converted to a carbon credit.

In one embodiment, enablement of the solar powered charger (operation 301) includes receiving an activation code from the server and matching the activation code to one of a plurality of valid activation codes stored in the solar powered charger.

Systems and methods for a solar powered utility have been described. Embodiments of the present may include circuits, components, systems and the like that perform operations. Alternatively, the operations of the present invention may be embodied in machine-executable instructions, which may be used to cause a general-purpose or special-purpose processor programmed with the instructions to perform the operations. Alternatively, the operations may be performed by a combination of hardware and software.

Embodiments of the present invention may be provided as a computer program product, or software, that may include a machine-readable medium having instructions stored thereon, which may be used to program a computer system (or other electronic device) to perform a process according to the present invention. A machine-readable medium may include any mechanism for storing or transmitting information in a form (e.g., software, processing application) readable by a machine (e.g., a computer). The machine readable medium may include, but is not limited to: magnetic storage media, optical storage media, magneto-optical storage media, read only memory, random access memory, erasable programmable memory, flash memory, or any other medium suitable for storing electronic instructions.

The term “coupled” as used herein may mean coupled directly to or indirectly to through one or more intervening components.

While some specific embodiments of the invention have been shown, the invention is not to be limited to these embodiments. The invention is to limited only by the scope of the appended claims.

What is claimed is:

1. A system, comprising:
a solar powered charger; and
a key configured to activate the solar powered charger, wherein the solar powered charger is enabled for one or more charge and discharge cycles to provide electrical energy to a device configured to be operated or charged by the solar powered charger.

2. The system of claim 1, wherein the key is controlled by an agent and provided in exchange for a monetary payment from a user of the solar powered charger to enable the one or more charge and discharge cycles of the solar powered charger.

3. The system of claim 1, wherein the key is controlled by a user of the solar powered charger and is configured to be programmed with credits for the one or more and discharge cycles in exchange for a monetary payment.

4. The system of claim 1, wherein the solar powered charger is configured to identify the device when the solar powered charger is coupled to the device, to record times of connection to the device and the electrical energy transferred to the device.

5. The system of claim 4, wherein the key is further configured to read and store usage information from the solar powered charger including an identifier of the device, the times of connection to the device, the electrical energy transferred to the device and an identifier of the solar powered charger.

6. The system of claim 5, wherein the key is further configured to communicate with a server via a connection through a cellular telephone network, wherein the usage information is transferred to the server.

7. The system of claim 6, wherein the usage information transferred to the server is converted to a carbon credit.

8. The system of claim 6, wherein the connection to the cellular telephone network comprises a connection to a cellular telephone via one of an electro-mechanical connection, an electromagnetic connection and an audio connection.

9. The system of claim 6, wherein the key is configured to receive an activation code from the server, wherein a plurality of valid activation codes are stored in the solar powered charger and wherein activation of the solar powered charger comprises matching the activation code to one of the plurality of valid activation codes.

10. The system of claim 4, wherein to detect the device the solar powered charger is configured to read a characteristic value of a resistor in a connection path between the device and the solar powered charger.

11. A system, comprising:
a solar powered charger; and
a cellular telephone configured to communicate with the solar powered charger, wherein the solar powered charger is configured to receive an activation code from a server via the cellular telephone, wherein the solar powered charger is enabled for one or more charge and discharge cycles to provide electrical energy to a device configured to be operated or charged by the solar powered charger.

12. The system of claim 11, wherein the activation code is provided by a service provider in exchange for a monetary payment from a user of the solar powered charger.

13. The system of claim 12, wherein the monetary payment comprises an online transaction via the cellular telephone with one of the service provider and a third-party facilitator.

14. The system of claim 11, wherein the solar powered charger is configured to identify the device when the solar powered charger is coupled to the device, to record times of connection to the device and electrical energy transferred to the device.

15. The system of claim 14, wherein the solar powered charger is further configured to transmit usage information from the solar powered charger to a server via a connection through a cellular telephone network, the usage information including an identifier of the device, the times of connection to the device, the electrical energy transferred to the device and an identifier of the solar powered charger.

16. The system of claim 15, wherein the solar powered charger is coupled to the cellular telephone network via the cellular telephone.

17. The system of claim 16, wherein the connection to the cellular telephone comprises one of an electro-mechanical connection, an electromagnetic connection and an audio connection.

18. The system of claim 11, wherein the activation code is compared to a plurality of valid activation codes stored in the solar powered charger and wherein the solar powered charger is activated if the activation code matches one of the plurality of valid activation codes.

19. A method, comprising:
enabling a solar powered charger for one or more charge/discharge cycles in exchange for a monetary payment;
connecting the solar powered charger to a device configured to be charged or operated by the solar powered charger;
recording usage data in the solar powered charger; and
uploading the usage data to a server.

20. The method of claim 19, further comprising re-enabling the solar powered charger for another one or more charge/discharge cycles in exchange for another monetary payment.

21. The method of claim 19, wherein enabling the solar powered charger comprises:
receiving an activation code from the server; and
matching the activation code to a plurality of valid activation codes stored in the solar powered charger.

22. The method of claim 21, wherein the activation code is transmitted from the server through a cellular telephone network to a cellular telephone configured to provide the activation code to the solar powered charger.

23. The method of claim 22, wherein the solar powered charger is directly coupled to the cellular telephone via one of an electro-mechanical link, an electromagnetic link and an audio link.

24. The method of claim 21, wherein the cellular telephone is configured to interface with an activation key and wherein the activation key is configured to interface with the solar powered charger.

25. The method of claim 24, further comprising transferring the activation code from the cellular telephone to the activation key and transferring the activation code from the activation key to the solar powered charger.

26. The method of claim 24, wherein the activation key is controlled by an agent, wherein the agent receives the monetary payment.

27. The method of claim 19, further comprising providing the solar powered charger to a user under a lease-purchase plan.

28. The method of claim 19, wherein the monetary payment is an electronic payment facilitated by a third-party provider over the cellular telephone network.

29. The method of claim 19, wherein the usage data comprises one or more of an identifier of the device, an identifier of the solar powered charger and the electrical energy delivered to the devices.

30. The method of claim 19, further comprising converting the usage data to a carbon credit and selling the carbon credit.
